(19) United States
(12) Patent Application Publication
(10) Pub. No.: US 2004/0089190 A1
(43) Pub. Date: May 13, 2004

(54) Transportation system with linear switched reluctance actuator for propulsion and levitation

(76) Inventors: Krishnan Ramu, Blacksburg, VA (US); Leonard A. Ferrari, Blacksburg, VA (US); Han-Kyung Bae, Carlsbad, CA (US); Philip J. Vallance, Odenton, MD (US)

Correspondence Address: Melvin K Silverman, Suite 500, 500 West Cypress Creek Road, Fort Lauderdale, FL, 33309, US

(21) Appl. No.: 10/291,925

(22) Filed: Nov. 8, 2002

(51) Int. Cl. B60L 13/04

(52) U.S. Cl. 104/281

(57) ABSTRACT

A frictionless linear switched reluctance propulsion system generates both a propulsive force for moving a load linearly, and a normal force for lifting the load. The normal force acts in a direction substantially perpendicular to a direction of the propulsive force.

This application claims the benefit under 35 USC section 120 of PCT/US01/15208, filed May 11, 2001.

### BACKGROUND OF THE INVENTION

The present invention relates generally to transportation systems utilizing electromagnetic propulsion, and more particularly to a transportation system utilizing linear switched reluctance propulsion.

As world population rises and urban areas become increasingly congested, the need for fast, reliable, energy-efficient and environmentally-friendly mass transportation becomes ever more urgent.

Transportation using electromagnetic propulsion is known. For example, magnetic levitation (mag-lev) systems are used in trains and similar forms of transportation. Benefits offered by mag-lev include a smooth, quiet ride at high speeds, with little mechanical wear on supporting infrastructure, since the systems are contactless and therefore frictionless. Mag-lev also tends to be energy-efficient and have a smaller environmental impact than conventional rail systems, due in part to the fact that pollutants are not generated.

However, drawbacks exist with known mag-lev systems. For example, separate electromagnetic arrangements are used for lift and propulsion. That is, known mag-lev systems typically employ a combination of superconducting magnets, permanent magnets or more conventional electromagnets for lift, along with linear induction or synchronous motors for propulsion. This tends to compound construction and manufacturing problems, create additional problems of reliability in regard to cooling requirements for the superconducting magnets, temperature sensitivity and demagnetization possibilities for the permanent magnets under fault conditions, and total reliance on electromagnets leading to heavy sets of electromagnets and additional costs.

Further, the induction or synchronous motors used for propulsion typically utilize complex distributed windings that are spread over the guideways or tracks for mag-lev vehicles. Such distributed windings tend to have high manufacturing costs and installation requirements and costs. Moreover, since component faults in one part of the windings are propagated along extended sections of the guideways or tracks by mutual coupling with other windings, such machines are not fault-tolerant and hence unreliable for continuous operation under all conditions including that of the fault condition. Since the windings are along the track or guideway it can be difficult to locate and repair or replace failing winding components without disrupting the flow of traffic on the guideway. In order to replace the failed component, a whole section of the phase belt for all phases must be dug out and replaced. Such a whole section may be as long as a few feet to a hundred feet in a mag-lev transportation system.

In view of the foregoing considerations, improvement in electromagnetic propulsion technologies and transportation systems is called for.

### SUMMARY OF THE INVENTION

According to embodiments of the invention, a propulsion system utilizing linear switched reluctance is provided. The propulsion system comprises a stator and a translator configured to be in electromagnetic engagement with each other, and force-generating means for application to one of the translator and stator to generate a propulsive force in combination with a normal force acting in a direction substantially perpendicular to a direction of the propulsive force. Thus, a propulsive force and a lifting force for contactless propulsion are provided in a single mechanism. In embodiments, the propulsion system utilizes individually-wrapped coils on either the stator or the translator, avoiding the problems with distributed coils that exist in the prior art.

### BRIEF DESCRIPTION OF THE DRAWINGS

FIG. 1 shows a stator and translator of a linear switched reluctance propulsion system according to an embodiment of the invention;

FIG. 2A shows a stator and a translator, wherein the translator has individually-wrapped coils;

FIG. 2B shows a stator and a translator, wherein the stator has individually-wrapped coils;

FIGS. 2C-2F illustrate propulsion of a translator relative to a stator, for a 4-pole translator;

FIG. 2G illustrates propulsion of a translator relative to a stator, for a 6-pole translator;

FIG. 2H illustrates propulsion of a translator relative to a stator, for an 8-pole translator;

FIG. 21 shows a power converter system for supplying current to coils;

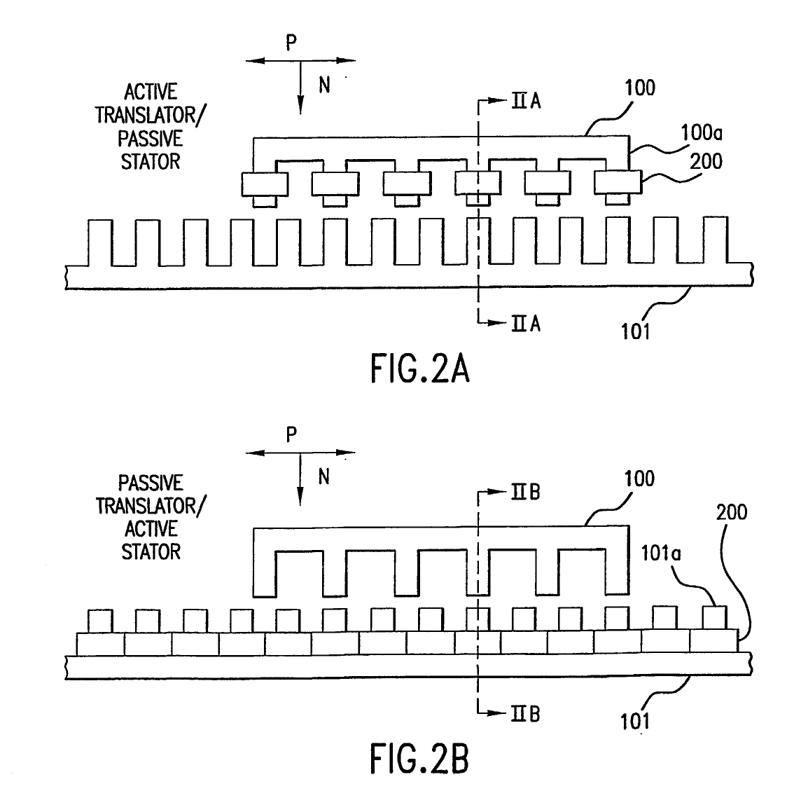

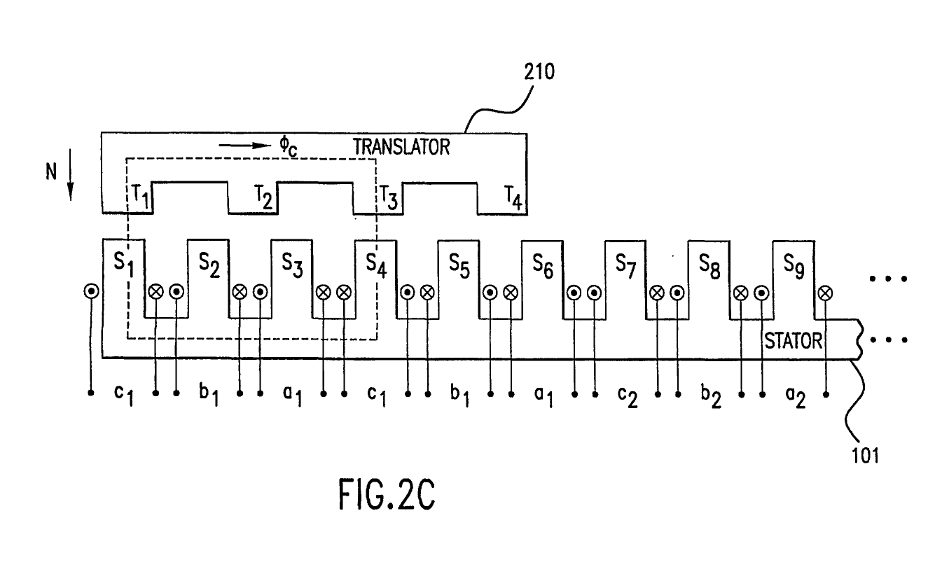

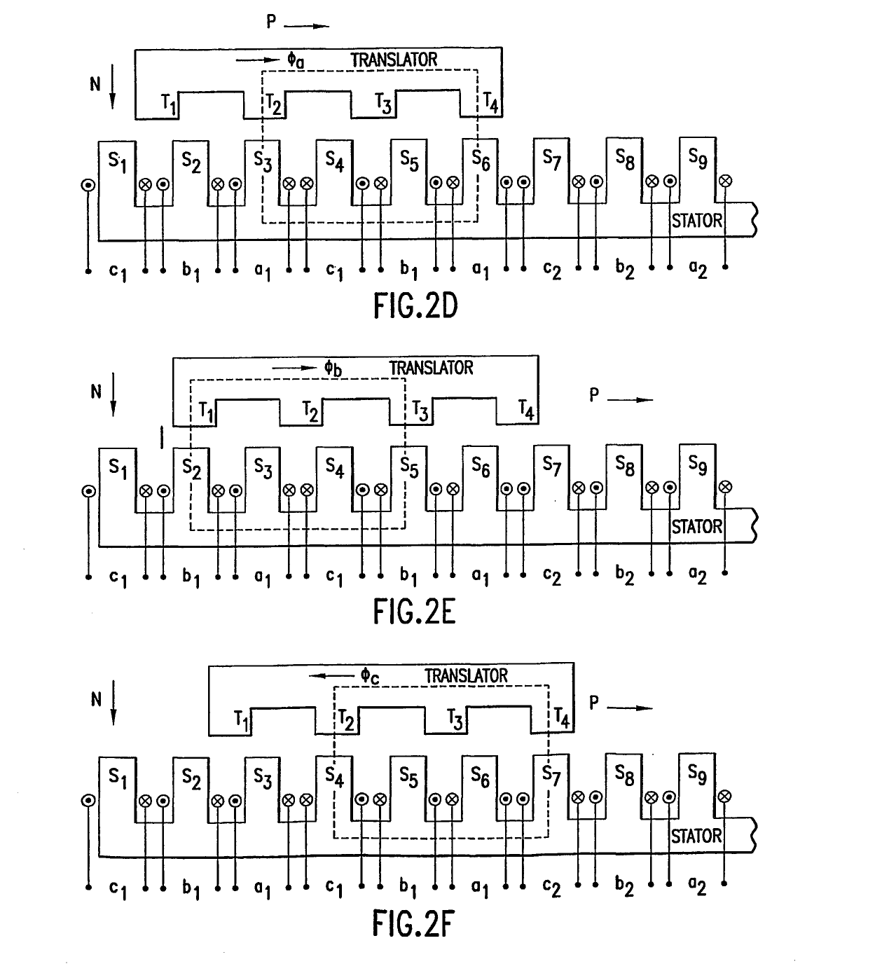

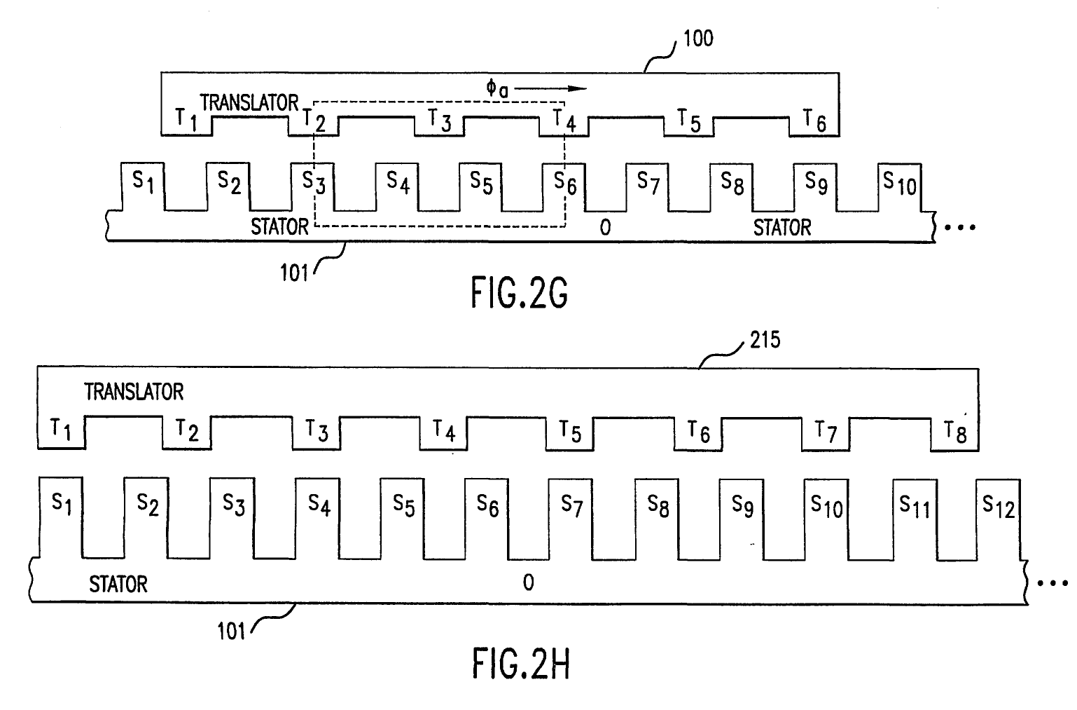

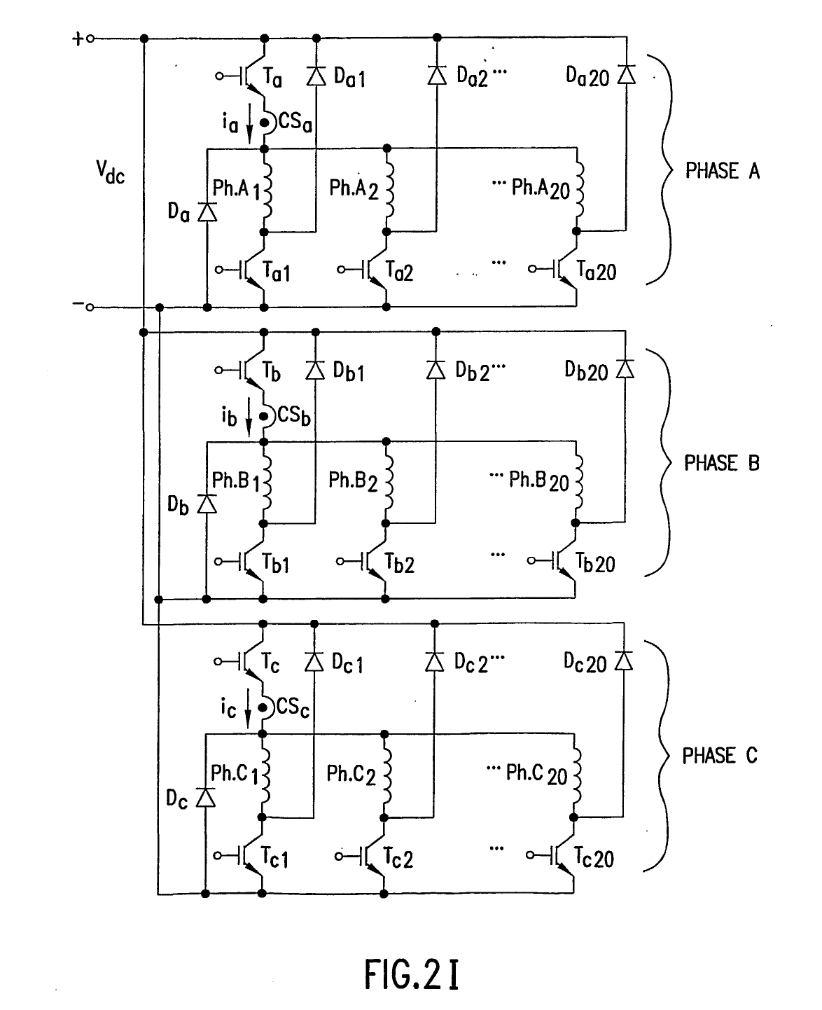

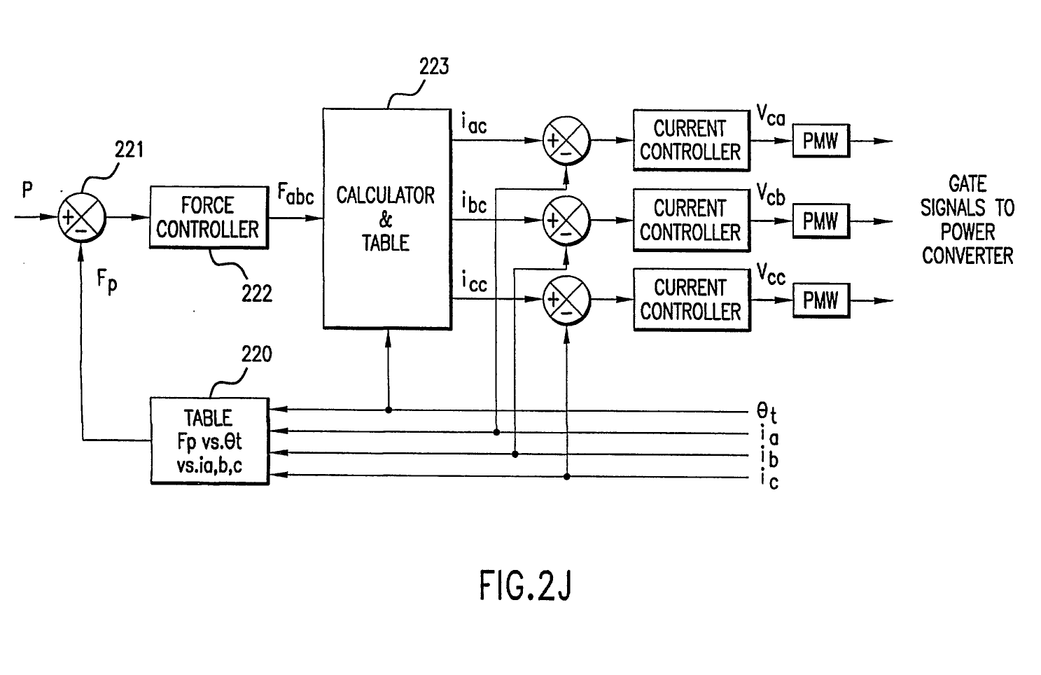

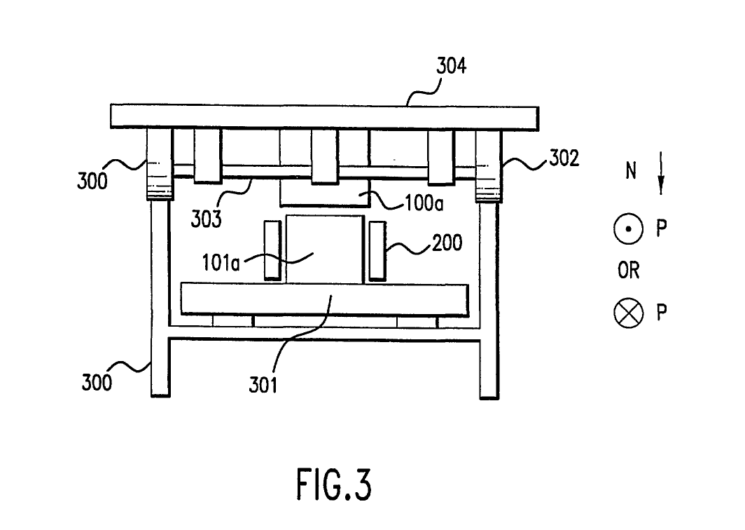

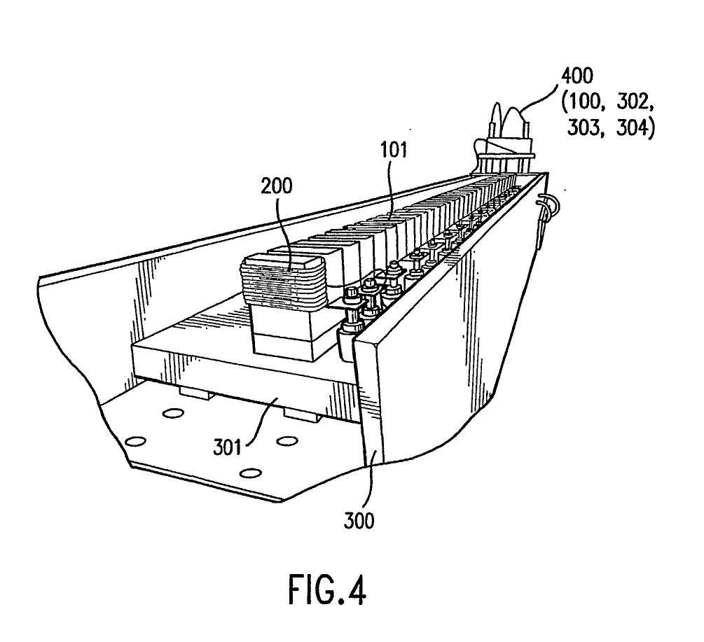

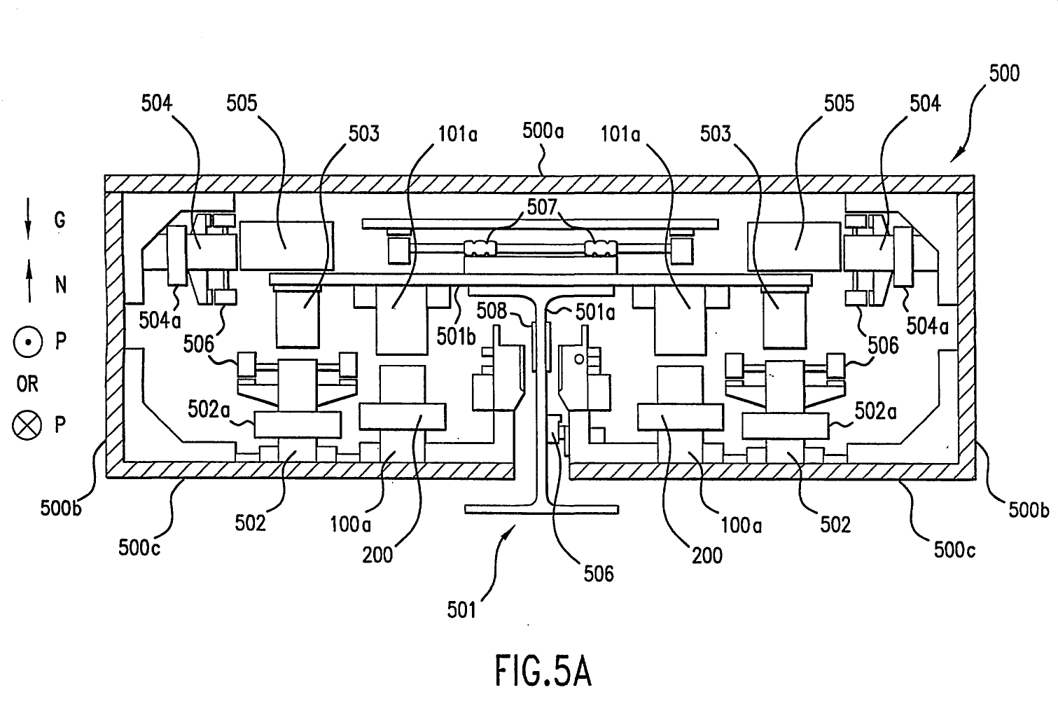

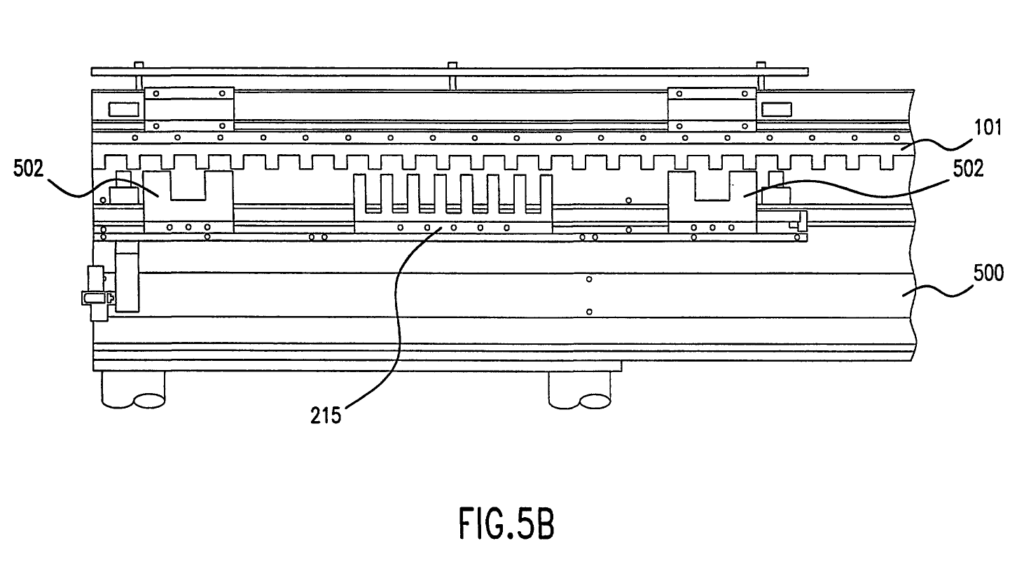

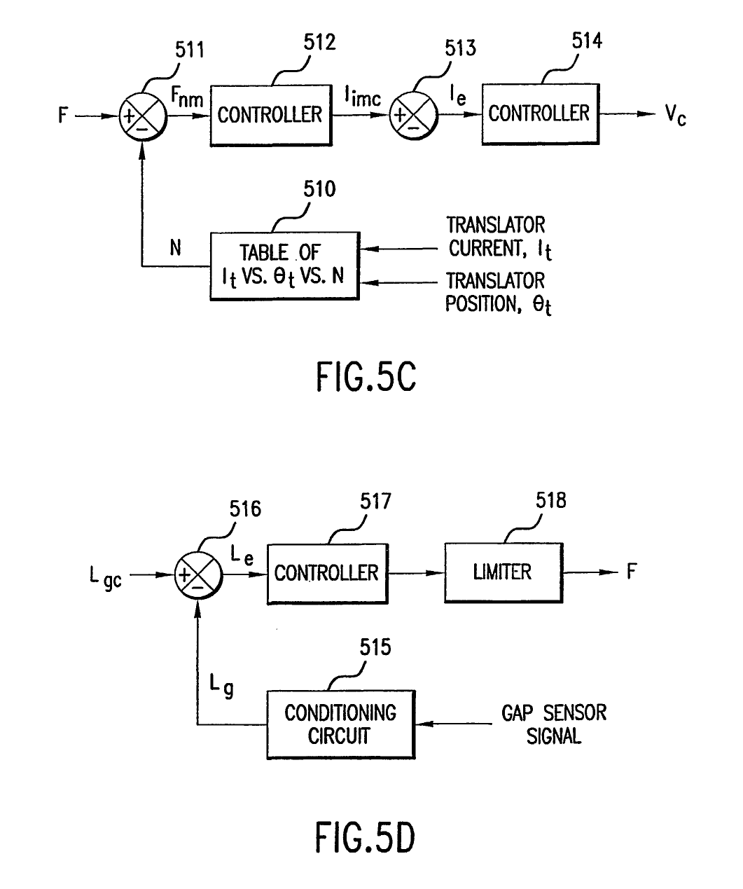

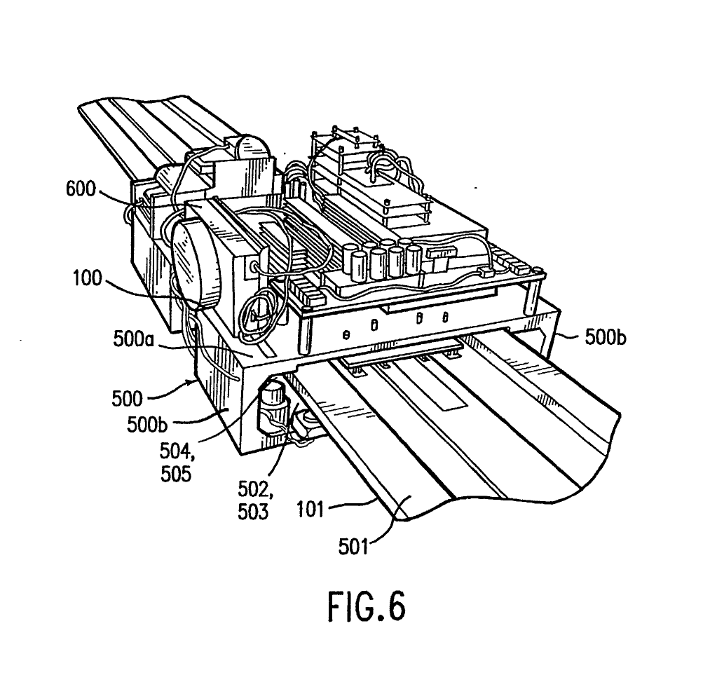

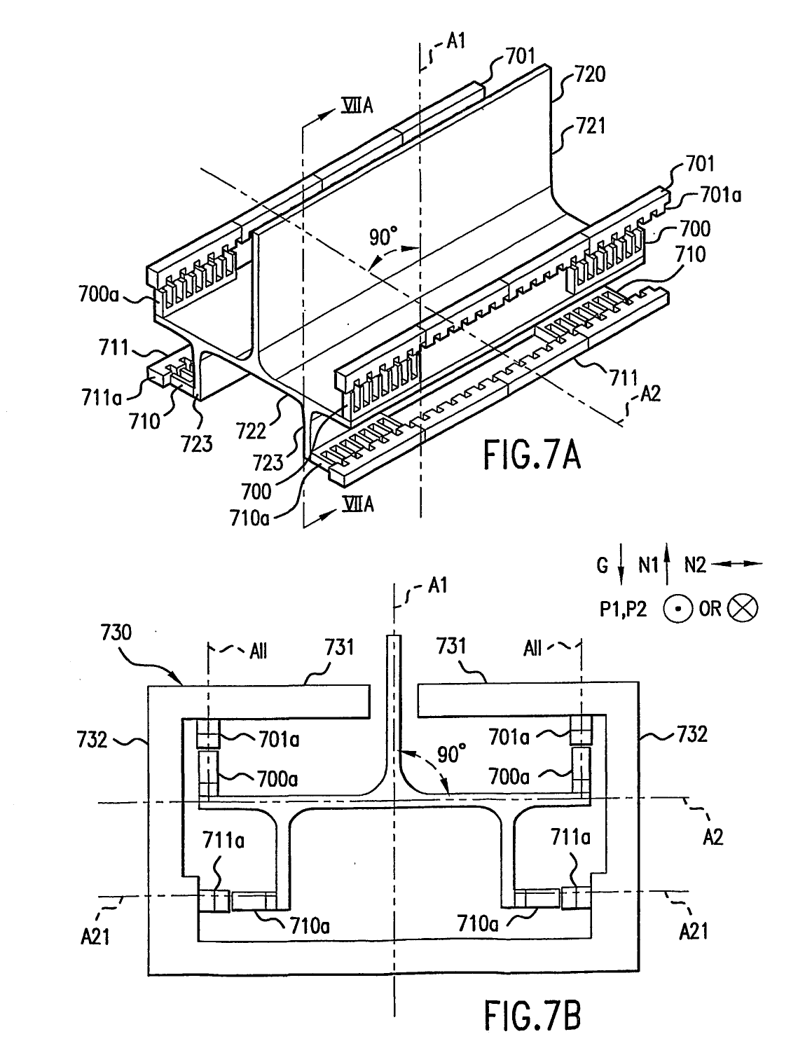

FIG. 2J shows a control system for the propulsive force;

FIG. 3 shows a cross-sectional view of one possible embodiment of a transportation system according to the invention, with an active stator and a passive translator;

FIG. 4 shows a perspective view of the embodiment shown in FIG. 3;

FIG. 5A shows a cross-sectional view of another possible embodiment of a transportation system according to the invention, with an active translator and a passive stator;

FIG. 5B shows a side view of the embodiment of FIG. 5A;

FIGS. 5C and 5D are functional block diagrams illustrating embodiments of control systems for the embodiment of FIG. 5A;

FIG. 6 shows a perspective view of the embodiment shown in FIG. 5A;

FIG. 7A shows a perspective view of another possible embodiment of a propulsion system according to the invention;

FIG. 7B shows a cross-sectional view of the embodiment of FIG. 7A; and

FIG. 8 shows another possible embodiment of a transportation system according to the invention.

### DETAILED DESCRIPTION OF THE INVENTION

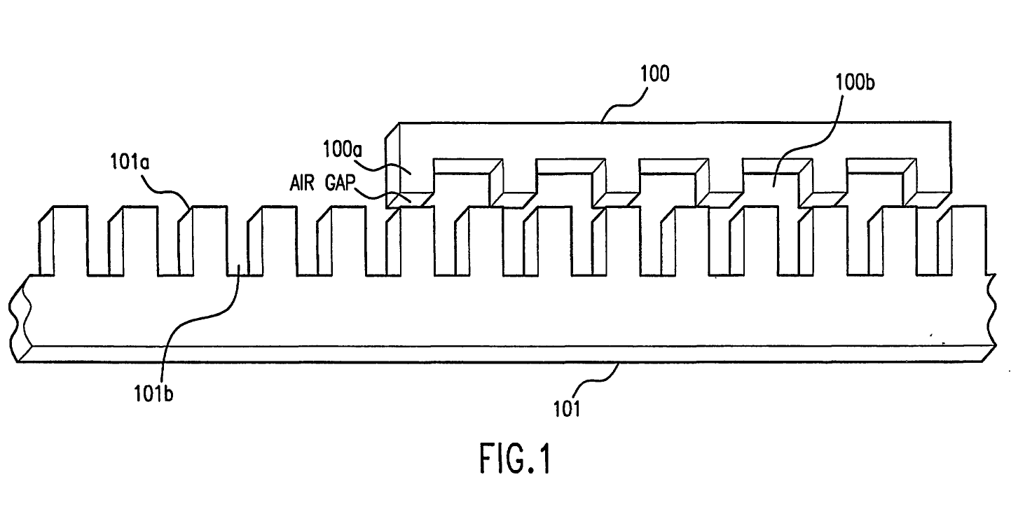

As shown in FIG. 1, according to embodiments the present invention comprises a translator 100 and a stator 101 configured to be in electromagnetic engagement with each other. The translator 100 and stator 101 are separated by an air gap. Each of the translator and stator comprises a plurality of linear, uniformly-spaced projections, 100a and 101a, respectively. The projections may also be referred to as teeth or poles. The projections 100a of the translator may be differently sized from the projections 101a of the stator. Similarly, spaces 100b between the projections of the translator may be differently sized from spaces 101b between the projections of the stator.

The translator 100 and stator 101 constitute elements of a linear switched reluctance machine (LSRM). A LSRM is a linear version of a rotary switched reluctance machine; rotary switched reluctance machines are well known. Generally, two types of LSRM are known: a longitudinal type, and a transverse type. The following description refers to a longitudinal-type LSRM.

According to embodiments as described in greater detail hereinafter, the stator poles may be arranged in sections. In each section, the ratio of stator poles in each section to translator poles may be 6 to 4. In an alternative embodiment, the ratio of stator poles in each section to translator poles may be 6 to 6. In yet another embodiment, the ratio of stator poles in each section to translator poles may be 6 to 8.

In embodiments, the translator and stator may, for example, be fabricated of a plurality of thin metal strips or laminations, bonded or fastened together to a desired thickness.

Referring now to FIGS. 2A and 2B, according to the invention, electrical coils (also referred to herein as “windings”) 200 are individually placed or wrapped around projections 100a of the translator, or projections 101a of the stator. The coils are placed either on the projections of the translator, as shown in FIG. 2A, or on the projections of the stator, as shown in FIG. 2B, but not both. Whichever component (translator or stator) has the coils is referred to as “active,” while the other is referred to as “passive.”

By placing the coils separately on each projection, the problems of distributed coils as in the prior art are avoided, because failing coils are easily identified and repaired or replaced. The coils wound around each individual projection are known as concentric coils.

According to embodiments of the invention, a translator and a stator are brought into a substantially linear spaced relationship with each other; i.e. the translator and stator extend linearly in substantially the same direction and are separated by an air gap as shown in FIGS. 1, 2A and 2B. Then, coils 200 are energized by application of phased currents in a controlled, pre-determined sequence. The energized coils form, in combination with the projections of the translator or stator, magnetic poles. A pattern of time-varying magnetic flux propagated through the poles generates electromagnetic forces which cause the translator 100 to move relative to the stator 101.

More particular, as shown in FIGS. 2A and 2B, the electromagnetic forces generated comprise both a propulsive force P which moves the translator linearly with respect to the stator, and a normal force N acting in a direction substantially perpendicular to a direction of the propulsive force. The normal force tends to attract the translator toward the stator. The foregoing is in contrast, as noted above, to existing mag-lev systems which use separate mechanisms for propulsive and lifting forces.

Moreover, by controlling the spacing between, and ratio of poles of the translator to poles of the stator, it is possible to generate propulsion without flux reversal.

With reference to FIGS. 2C-2H, a description follows of mechanisms for generating the propulsive and normal forces as described above. First, an embodiment is described which utilizes a ratio of 6 stator poles in each section to 4 translator poles. While such an embodiment generates propulsive and normal forces, it is also subject to flux reversal. Flux reversal increases core losses that are undesirable. To overcome flux reversal in a 6-to-4 stator-to-translator configuration necessitates a level of complexity of circuitry and coil arrangements that may be impractical.

Accordingly, the present inventors conceived embodiments wherein the ratio of stator poles in each section to translator poles is 6 to 6, or 6 to 8. These embodiments enable the normal and propulsive forces as noted above, but without flux reversal. Description of these embodiments follows the description of the 6-to-4 configuration.

FIG. 2C shows a translator 210 and a stator 101. The translator 210 has 4 poles denoted T1, T2, T3 and T4. The stator 101 maybe regarded as constituting repeating sections of 6 poles. That is, the 6 stator poles S1, S2, S3, S4, S5, S6 are identical to statorpoles S7, S8, S9, S10, S11, S12, which are identical to poles S13-S18, and so on. When coils on the repeating sections of stator poles are energized as described below, the translator is propelled along the repeating sections.

Further shown in FIG. 2C are coils wrapped around projections or poles of the stator 101. In FIG. 2C, coils are represented by the symbols “cross” (\hat{×}) and “dot” (⊙), showing a direction of current flow in coil windings as conventionally understood. I.e., the cross symbol indicates a current going into the coil terminal, and the dot symbol indicates a current coming out of that terminal.

Coils c1′ and c1 are wrapped around stator poles S4 and S1, respectively. Coils c1′ and c1 are connected in series to form a phase winding, or “phase” identified herein by the associated stator poles, i.e., phase S1-S4. Similarly, coils b1′ and b1 are wrapped around stator poles S5 and S1, respectively, and are connected in series to form a phase S1-S5. Further, coils a1′ and a1 are wrapped around stator poles S6 and S3 and are connected in series to form a phase S3-S6.

The pattern of phase windings as described above with reference to the first section of stator poles S1-S6 is repeated in each of the sections of the stator 101.

To propel the translator along the stator, the phase windings (phases) are energized in a controlled, pre-determined sequence. More particularly, the S1-S4 phase is energized to produce magnetic flux by as shown by the dashed lines in FIG. 2C. The path of magnetic flux φ_{c} has a direction from left to right as shown. Magnetic flux φ_{c} tends to pull translator poles T1 and T3 into alignment with stator poles S1 and S4, respectively. At this time an attractive force between the stator and rotor poles is at a maximum and is directed in a direction N as shown. The N-directed force is known as the normal or lift force.

To move the translator 210 linearly with respect to the stator 101, for example to the right as viewed in FIG. 2C, a propulsion force must be generated. In the relative positions of the stator and translator as shown in FIG. 2C, the translator poles T2 and T4 are out of alignment with stator poles S3 and S6, which have the S3-S6 phase winding. Referring now to FIG. 2D, the S3-S6 phase is energized to produce magnetic flux φₐ, represented by the dashed lines. and having the direction (from left to right of the figure) shown. Energizing the S3-S6 phase as shown FIG. 2D produces a propulsion force P to the right of the figure, pulling T2 and T4 into alignment with S3 and S6. Thus, the propulsion force P acts in a direction substantially perpendicular to a direction of force N.

Now, the translator poles T1 and T3 are out of alignment with S2 and S5, and by energizing the coils on the stators constituting the S2-S5 phase, the translator poles T1 and T2 move into alignment with S2 and S5, respectively, as shown in FIG. 2E. In the process, a propulsion force P in the left to right direction, and an attraction force N substantially perpendicular to force P, have developed.

Note also that the flux path of magnetic flux φ_{b} as shown in FIG. 2E is in the direction from left to right. At this time, to move the translator any further, the S4-S7 phase must be energized by energizing coils c1′ and c2 as shown in FIG. 2F. However, this results in the path of flux φ_{c} being reversed (as seen by the direction of the currents in the energized phase; i.e., the coils around stator poles S4 in the left-hand 6-pole stator section, and S7 in the right-hand 6-pole stator section) and in the opposite direction to the previous flux paths. Even though flux φ_{c} has produced the normal and propulsion forces, the change of direction of the flux (i.e., a flux reversal) requires energy to be expended to overcome the flux of the phase B winding, and also in increased core losses. While the flux reversal could be prevented by additional coils, control circuitry and power expenditure, this would add to complexity and cost.

Thus, according to alternative embodiments of the invention, flux reversal may simply and inexpensively avoided. Such an embodiment is shown in FIG. 2G. FIG. 2G shows a stator 101 comprising repeating sections of 6 poles, as in FIGS. 2C-2F. However, translator 100 has 6 poles, T1-T6.

In the relative positions of the translator 100 and stator 101 as shown in FIG. 2G, the translator has been moved by a propulsive force P in a left-to-right direction by the energizing of a phase S3-S6, corresponding to stator poles S3 and S6, to bring translator poles T2 and T4 into alignment with poles S3 and S6, respectively. That is, as in FIGS. 2C-2F, poles S3 and S6 are wound with coils (not shown) coupled in series to form a phase S3-S6. Similarly, coil windings on poles S1 and S4, S2 and S5 in the left-hand stator section are respectively coupled in series. In the right-hand stator pole section of poles S7-S12 (S11 and S12 are not shown), coil windings of the poles are coupled identically to the poles in the left-hand section. That is, the right-hand section of the stator has phases S7-S10, S8-S11, S9-12, and so on, Before moving into the position shown in FIG. 2G, T1 and T3 had been aligned with S1 and S4 by energizing the S1-S4 phase.

To move the translator rightward again, phase S2-S5 is energized to bring poles T1 and T3 into alignment with poles S2 and S5, respectively. Next, however, instead of energizing a phase S4-S7 as with the 4-pole translator, a phase S7-S10 is energized, to bring T4 and T6 into alignment with S7 and S10, respectively. This avoids the flux reversal of the 4-pole translator to 6-pole stator section configuration described above, because the current in the coil windings will have the same directionality as in the previous phases (see FIGS. 2C-2F for current direction in coil windings).

With reference to FIG. 2G, a pattern of coil energizing for the 6-pole translator to 8-pole stator, which avoids flux reversal, is given in Table 1 below:

TABLE 1

| Phase energized | Stator poles aligned with | Translator poles |
|---|---|---|
| S1-S4 | S1-S4 | T1-T3 |
| S3-S6 | S3-S6 | T2-T4 |
| S2-S5 | S2-S5 | T1-T3 |
| S7-S10 | S7-S10 | T4-T6 |
| S3-S6 | S3-S6 | T1-T3 |
| S8-S11 | S8-S11 | T4-T6 |
| S7-S10 | S7-S10 | T3-T5 |
| S9-S12 | S9-S12 | T4-T6 |
| S8-S11 | S8-S11 | T3-T5 |
| S7-S10 | S7-S10 | T2-T4 |
| S9-S12 | S9-S12 | T3-T5 |
| S8-S11 | S8-S11 | T2-T4 |
| S7-S10 | S7-S10 | T1-T3 |

An embodiment with 8 translator poles to 6 stator poles per section is shown in FIG. 2H. In the embodiment of FIG. 2H, the translator 215 can be moved along stator 101 by application of phased currents in a pre-determined sequence similar to that shown in Table 1 for the 6-pole translator, avoiding flux reversal. Table 2 gives an energizing sequence for an 8-pole translator as shown in FIG. 2H, for two 6-pole sections of the- stator and assuming that the stator is active.

TABLE 2

| | | Translator | |
|---|---|---|---|
| Phase energized | Stator poles aligned with | poles | Comments |
| S1-S4 | S1-S4 | T1-T3 | Simultaneous |
| S7-S10 | S7-S10 | T5-T7 | Simultaneous |
| S3-S6 | S3-S6 | T2-T4 | Simultaneous |
| S9-S12 | S9-S12 | T6-T8 | Simultaneous |
| S2-S5 | S2-S5 | T1-T3 | Simultaneous |
| S8-S11 | S8-S11 | T5-T7 | Simultaneous |
| S7-S10 | S7-S10 | T4-T6 | |
| S3-S6 | S3-S6 | T1-T3 | Simultaneous |
| S9-S12 | S9-S12 | T5-T7 | Simultaneous |
| S8-S11 | S8-S11 | T4-T6 | |
| S7-S10 | S7-S10 | T3-T5 | |
| S9-S12 | S9-S12 | T4-T6 | |
| S8-S11 | S8-S11 | T3-T5 | |
| S7-S10 | S7-S10 | T2-T4 | |
| S9-S12 | S9-S12 | T3-T5 | |
| S8-S11 | S8-S11 | T2-T4 | |
| S7-S10 | S7-S10 | T1-T3 | |
| S9-S12 | S9-S12 | T2-T4 | |
| S8-S11 | S8-S11 | T1-T3 | |

As indicated in Table 2 in the first, second, third and fifth paired entries, the configuration of an 8-pole translator to 6-pole per section stator allows two phases to be simultaneously energized, resulting in a doubling of the propulsive and normal forces. Only a limited sequence of simultaneous energizing is shown in Table 2, due to the length of the stator in the example being only two sections. However, in a more extensive stator, simultaneous energizing could be repeated more often (for example, in a theoretical stator of unlimited length, simultaneous energizing could be repeated an infinite number of times).

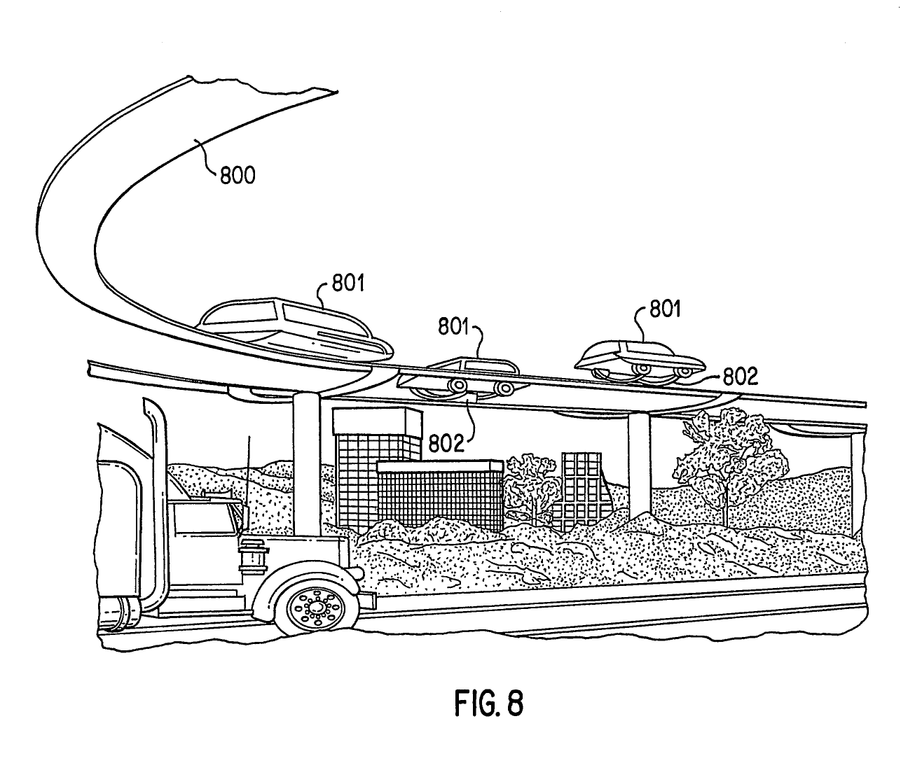

FIG. 21 shows one possible embodiment of a power converter for supplying current to the phase windings as described above. In the example shown, the power converter is for a stator having 20 6-pole sections. Each 6-pole section, as described above, has 3 phases.

FIG. 2I shows a DC voltage source V_{dc} coupled to three phases A, B, C. Each phase operates identically, so the following description is of phase A only.

Each phase winding Ph. A₁, Ph. A₂, . . . , Ph. A₂₀ is individually coupled in series to a switch embodied, for example, as a transistor Tₐ₁, Tₐ₂, . . . Tₐ₂₀. Further, each winding Ph. A₁, Ph. A₂, . . . , Ph. A₂₀ is individually coupled at one end to a diode Dₐ₁, Dₐ₂, . . . Dₐ₂₀ coupled to the positive rail of the voltage supply V_{dc}.

At the other end, each winding is tied to a common switch embodied, for example, as a transistor Tₐ, through a current sensor (for example, a Hall current sensor). Each winding is further tied to a common diode Dₐ.

A particular phase winding Ph. A₁, Ph. A₂, . . . , Ph. A₂₀ is energized by turning on the common switch Tₐ and the particular individual switch Tₐ₁, Tₐ₂, . . . Tₐ₂₀ coupled to the phase winding. When current has to be controlled, the common switch Tₐ is turned off, forcing the current to freewheel with the individual switch and the common diode Dₐ. If current needs to be completely turned off in a winding, both the common and individual switches are turned off, forcing the two diodes coupled to the winding to carry the current back to the voltage supply, resulting in decay and eventual extinction of the current.

FIG. 2J shows one possible embodiment of a control system for the propulsive force described above. An absolute translator position with respect to stator poles θₜ, and phase currents iₐ, i_{b}, and i_{c} (corresponding, for example, to phases A, B and C as described above) are input to a table 220 in a computer memory, for example. The table stores the three-dimensional relationships between the currents iₐ, i_{b}, i_{c}, position θₜ and actual propulsion force Fₚ. Given the values iₐ, i_{b}, i_{c} and position θₜ, the actual propulsion force Fₚ can be computed and output from the table.

The actual propulsion force Fₚ is input to add/subtract operator 221. Also input to the add/subtract operator 221 is the required force P for moving the translator with its load. The output of the add/subtract operator is the difference between P and Fₚ.

The difference between P and Fₚ is input to a force controller 222, which may be embodied as a proportional and integral controller. The force controller outputs a signal F_{abc} which specifies the forces that need to be produced by the 3 stator phases at every instant.

The signal F_{abc} is input to a calculator and table 223. The calculator and memory are used to identify the phases that need to be energized, and to calculate and output commands for generating currents i_{ac}, i_{bc} and i_{cc} corresponding to phases A, B and C, respectively, needed to generate the required forces.

Each of signals i_{ac}, i_{bc} and i_{cc} is input to an add/subtract operator, along with signals iₐ, i_{b} and i_{c}, respectively. The output of the add/subtract operators is the difference between the respective currents. Each difference signal is amplified and limited by a current controller, typically a proportional and integral controller.

The current controllers output control voltages V_{ca}, V_{cb}, and V_{cc} for each of the phases. The control voltages are converted into pulse width modulated (PWM) signals for control of power converters, for example, as described above.

FIG. 3 shows one possible embodiment of a transportation system according to the invention, utilizing the LSRM propulsion described in the foregoing. FIG. 3 includes a cross-sectional view of a translator projection 100a, and a coil 200 on a stator projection 101a as seen along section lines IIB in FIG. 2B

It is noted that additional elements not shown in FIG. 2B are included in FIG. 3. The additional elements comprise engagement means for bringing translators 100 and stators 101 into a substantially linear spaced relationship with each other. The engagement means comprise load-bearing member 304 and wheels 302 rotatable about axle 303. The translator projection 100a is attached to the load-bearing member 304.

The wheels 302 are in contact with a support structure 300. The support structure supports baseplate 301, which supports the stator projection 101a and coil 200. In the embodiment shown in FIG. 3, the stator is active while the translator is passive.

By application of phased currents to coils 200 via LSRM propulsion as described above, a propulsive force P acting in a direction as shown in FIG. 3 (i.e., into or out of the plane of the figure, as conventionally understood) is generated. The propulsive force P causes the translator 100 to be moved or translated in the P direction relative to the stator 101. Consequently, the engagement means and loading-bearing member (and any load attached to or supported by the load-bearing member) move along the support structure on the wheels 302. The support structure may be embodied as a track extending between points.

Additionally, a normal force N acting in a direction substantially perpendicular to a direction of the propulsive force P is generated by the LSRM propulsion, as farther shown in FIG. 3. The normal force N attracts the translator to the stator, which by suitable arrangement can be utilized to lift a load as described hereinafter.

FIG. 4 shows a perspective view of the embodiment described with reference to FIG. 3. FIG. 4 shows a support structure 300 embodied as a steel I-beam, baseplate 301, active stator 101 and coils 200. A vehicle 400 including translator 100, wheels and axle 302 and 303, and load-bearing member 304 (elements 100, 302, 303 and 304 are not directly visible) is also shown.

FIG. 5A shows another possible embodiment of a transportation system according to the invention. FIG. 5A includes a cross-sectional view of translator projections 100a and coils 200 on translator projections 100a as seen along section lines IIA in FIG. 2A. Thus, in the embodiment shown in FIG. 5A, the translator is active while the stator is passive.

It is further noted that additional elements not shown in FIG. 2A are included in FIG. 5A. The additional elements comprise a support structure 501 and engagement means 500 configured to engage the support structure 501. The stator projections 101a are attached to the support structure 501. The translator projections 100a are attached to the engagement means 500. The engagement means bring the translator projections and the stator projections into a substantially linear spaced relationship with each other.

More specifically, the support structure 501 comprises a first member 501a and a second member 501b attached to first member 501a at substantially right angles. The stator projections 101a are attached to the second member 501b of the support structure.

Further, the engagement means 500 include a load-bearing member 500a and lateral members 500b attached to the load-bearing member 500a. Engagement members 500c are attached to lateral members 500b and translator projections 100a are attached to engagement members 500c. The engagement members 500c bring the translator projections 100a into a substantially linear spaced relationship with the stator projections 101a.

Also shown in FIG. 5A are shock protectors 506 and landing wheels 507 for engaging the support structure.

FIG. 5B shows a side view of the embodiment of FIG. 5A where the translator is an 8-pole translator.

As noted earlier, in the embodiment shown in FIG. 5A, the translator is active and the stator is passive. By application of phased currents to coils 200 according LSRM propulsion as described above, a normal force N acting in opposition to a gravitational force G is generated, as shown in FIG. 5A. The LSRM propulsion also generates a propulsive force P acting in a direction substantially perpendicular to a direction of the normal force N, as further shown in FIG. 5A. The normal force N acts to levitate the engagement means and any additional load attached to or supported by the engagement means, for example on the load-bearing member 500a. At the same time, the propulsive force P moves or translates the engagement means and additional load along the support structure 501, which may be embodied as a track extending between points. Accordingly, contactless, frictionless propulsion is achieved.

According to the invention, to supplement the normal force N as needed, levitation magnets 502 may be provided on the engagement means. The levitation magnets 502 act in conjunction with levitation reaction rails 503 connected to the support means to provide additional lift.

More specifically, it may be advantageous to supplement the levitation force (the normal force N as described in the foregoing) produced by the LSRM propulsion. For example, the LSRM propulsion system may need to carry a 7500 pound load, while the normal component of the LSRM system only produces 7000 pounds of lift. Accordingly, levitation magnets 502 may be provided to supply the required extra 500 pounds of lift.

To adaptively provide the needed extra lift from the levitation magnets, a system as illustrated in FIG. 5C may be used, according to one embodiment of the invention. In FIG. 5C, a translator current Iₜ (current in translator coils 200) and a translator position with respect to the stator, θ∈ are fed into a table of values 510. For each value of the translator current and translator position, the corresponding normal force N can be calculated.

According to this embodiment, the normal force N for a given pair of translator current and translator position values may then be fed into an add/subtract operator 511. Also input to the add/subtract operator is the required lift force F (i.e., as in the above example, 7500 pounds of lift). The output of the operator 511 is the difference between F and N. Subtracting the normal force N generated by the propulsion system from the required lift force F yields the supplemental force Fₙₘ that needs to be provided by the levitation magnets 502.

The supplemental force Fₙₘ may then be fed into a controller 512 to derive the current, I_{lmc} that needs to be supplied to levitation magnet windings 502a to generate the required supplemental force Fₙₘ. The controller 512 may be adaptive, to take into account the air gap that needs to be maintained between the levitation magnets 502 and levitation reaction rails 503. Alternatively, the current I_{lmc} may be obtained, for example, from a stored table in a computer memory.

The required levitation magnet winding current I_{lmc} may then be fed into an add/subtract operator 513. Also input to the add/subtract operator 513 is a sensed (actual) levitation winding current Iₗₘ. The actual current Iₗₘ may be sensed, for example, with a Hall sensor. The output of the operator 513 is the difference, Iₑ, between the sensed current Iₗₘ and the required current I_{lmc}.

The difference current Iₑ may then be fed into a controller 514, which processes the difference current to produce a control voltage V_{c}. Control voltage V_{c} is proportional to the duty cycle of a power converter feeding the levitation magnet windings 502a. By using the control voltage V_{c} to pulse width modulate the duty cycle of the power converter, the voltage applied to the windings 502a may be varied until the actual winding current Iₗₘ and the required winding current I_{lmc} are equal. Thus, the required supplemental force Fₙₘ may be provided.

Further, according to an embodiment of the invention, a system as illustrated in FIG. 5D may be provided for ensuring that the air gap between the levitation magnets 502 and levitation reaction rails 503 is sufficient, so that a comfortable ride is achieved. The system outputs a required lift force F that is proportional to a desired air gap.

According the embodiment of FIG. 5D, a gap sensor signal is input to a conditioning circuit 515. The conditioning circuit eliminates noise from the gap sensor signal. The output of the conditioning circuit is an actual gap signal L_{g}.

The actual gap signal L_{g} is input to an add/subtract operator 516. Also input to the add/subtract operator 516 is a desired air gap signal, L_{gc}. The output of the add/subtract operator 516 is a difference signal Lₑ. The difference signal Lₑ is input to a controller 517 which produces an output that will null the difference signal rapidly. The output of the controller 517 may be further processed by a limiter 518. The output of the limiter 518 is a required lift force signal F that is proportional to the desired air gap.

Also according to an embodiment of the invention, guidance magnets 504 may be provided laterally on the engagement means to stabilize the engagement means and any additional load carried by the engagement means. The guidance magnets act with guidance reaction rails 505 connected to the support means to correct for lateral disturbances of the engagement means and its load about axes of the support structure. The guidance magnets provide a force that can be positive or negative in a direction (a bi-directional force) that is perpendicular to a direction of propulsion, as well to a direction of the levitation forces.

According to this embodiment, the force generated by the guidance magnets may be produced by subjecting the windings 504a of the guidance magnets to a current that is appropriate to generate a counterforce that balances lateral forces acting on the system, so that a desired gap between the guidance magnet core and its reaction rail 505 is maintained. Along lines similar to those discussed in connection with FIGS. 5C and 5D, the current required to generate this counterforce may be obtained from a difference gap signal, generated from the difference between a desired gap signal and an actual gap signal measured using a gap sensor. This difference gap signal may be amplified and conditioned using a controller, yielding a control voltage that is proportional to the current that is required in the windings 504a of the guidance magnets. The control voltage varies the duty cycle of the power converter to generate the required current and hence the required counterforce.

Further shown in FIG. 5A is a position encoder 506 for measuring the absolute position of the translator position along the track as it moves, utilizing sensor strips 508. This encoder works on the principle of magnetic pick-up and it can be realized in many ways using commercial systems. The absolute position can also be obtained by sensorless methods without using such encoders, from the winding voltage and current signals of the propulsion system of the LSRM system.

FIG. 6 shows a perspective view of the embodiment described with reference to FIG. 5A. FIG. 6 shows a support structure 501 embodied as a steel beam, and engagement means 500 embodied as metal rails comprising load bearing member 500a, lateral members 500b and engagement members 500c substantially encircling the support structure. The embodiment further includes translators 100 (not directly visible) on the engagement means and stators 101 (not directly visible) on an underside of the support structure 501.

Further shown are levitation magnets 502 (not directly visible) on the engagement means and a levitation reaction rail 503 (not directly visible) on an underside of the support structure. Also shown are guidance magnets 504 (not directly visible) and guidance reaction rails 505 (not directly visible) on the support structure.

A load 600 including control electronics is supported by load-bearing surface 500a.

Yet another alternative embodiment of the invention is shown in FIGS. 7A and 7B. FIG. 7A includes elements of an LSRM propulsion system as described in the foregoing. The elements include first translators 700 and first stators 701 comprising first translator projections 700a and first stator projections 701a, respectively. The first translators 700 and first stators 701 are arranged in a substantially linear spaced relationship with respect to each other.

The elements further include second translators 710 and second stators 711 comprising second translator projections 710a and second stator projections 711a, respectively. The second translators 710 and second stators 711 are arranged in a substantially linear spaced relationship with respect to each other, and further, have an orientation which is substantially at right angles to an orientation of the first translators and first stators. That is, as seen more clearly in FIG. 7B, an axis A11 of first translator projections 700a and first stator projections 701a is substantially parallel to an axis A1. An axis A21 of second translator projections 710a and second stator projections 711a is substantially parallel to an axis A2 which is perpendicular to axis A1.

Also shown in FIG. 7A are engagement means 720. The engagement means includes a spine member 721 connected at substantially right angles to a center member 722. Flange members 723 are connected to center member 722 so as to be substantially bilaterally symmetrical and oriented at substantially right angles with respect to spine member 721. First translators 700 are attached to center member 722, and second translators 710 are attached to flanges 723.

FIG. 7B shows a cross-sectional view of FIG. 7A as seen along section lines VIIA. It is noted that additional elements not shown in FIG. 7A are included in FIG. 7B. The additional elements comprise a support structure 730. Support structure 730 includes upper members 731 and side members 732. The first stator projections 701a are attached to the upper members 731. The second stator projections 711a are attached to the side members 732. The engagement means 720 are configured to engage the support structure 730. The engagement means bring the translator projections and the stator projections into a substantially linear spaced relationship with each other.

By application of LSRM propulsion as described above to the embodiment shown in FIG. 7B, it is possible to generate normal forces and propulsive forces for each of the orientations of translators and stators. More particularly, LSRM propulsion applied to the first translators and stators 700 and 701 generates a normal force N1 for levitation and a propulsive force P1 for propulsion. At the same time, LSRM propulsion applied to second translators and stators 710 and 711 generates a normal force N2 acting in a direction substantially perpendicular to a direction of the N1 force, for lateral guidance and stabilization. The LSRM propulsion applied to second translators and stators 710 and 711 also generates a propulsive force P2 acting in substantially the same direction as a direction of the force P1.

As with the earlier-discussed embodiments, the forces generated can be used to levitate and propel engagement means 720, as well as a load supported by the engagement means, along support structure 730, which may be embodied as a track extending between points. Moreover, construction and control are simplified because the propulsion system is integrated; that is, only LSRM propulsion is needed, as opposed to the supplemental levitation magnets and guidance magnets discussed in connection with the embodiment of FIG. 5.

As seen in FIG. 7A, a ratio of 8 translator poles to 6 stator poles may be used.

It may be readily perceived that a wide variety of practical and beneficial applications are encompassed by the invention. For example, a high speed, energy-efficient and non-polluting rapid transit system is realizable at comparatively low cost. Such a system could be dual mode, wherein a personal automobile is driven under its own power on commonly-used roadways to a station. At the station, the automobile, along with its driver and passengers, could be loaded onto a pallet configured to receive and retain the automobile. The pallet could be open or closed. If closed, the pallet could include environmental controls for the comfort of the passengers.

The pallet could be removably or permanently affixed to engagement means as described above. Using LSRM propulsion as described, the engagement means would carry the pallet and its load along a support structure extending between points. Such a support structure could be, for example, an elevated track between stations. The track would not require any electronics, since these would be incorporated into the engagement means, which would have active translators. Thus, the track could be quickly and inexpensively constructed.

Moreover, the system would utilize lift forces inherently produced by the LSRM propulsion, as noted above, avoiding the need for additional, complex devices for levitation as in existing systems. Only supplemental levitation magnets would be implemented, or integrated LSRM drives oriented at right angles to each other, as described above.

One conceivable embodiment of a personal electric rapid transit system as described in the foregoing is illustrated in FIG. 8. FIG. 8 shows a support structure embodied as an elevated track 800, with personal automobiles 801 being conveyed on pallets 802 along the track 800.

In addition to use in a high-speed mag-lev personal rapid transit system, other useful applications of the invention include use in airport and theme park transport systems, amusement part rides, magnetic resonance imaging tables, XY tables such as used in machine shops, elevators, conveyors, door openers, and commuter trains.

Several embodiments of the present invention are specifically illustrated and described herein. However, it will be appreciated that modifications and variations of the present invention are covered by the above teachings and within the purview of the appended claims without departing from the spirit and intended scope of the invention.

The invention claimed is:

1. A propulsion system comprising:
a stator and a translator configured to be in electromagnetic engagement with each other; and
force-generating means for application to one of said translator and stator to generate a propulsive force in combination with a normal force acting in a direction substantially perpendicular to a direction of said propulsive force.

2. The propulsion system of claim 1, further comprising engagement means configured to engage a support structure, said engagement means bringing said stator and said translator into a substantially linear spaced relationship with each other.

3. The propulsion system of claim 2, further comprising levitation magnets arranged on said engagement means, for providing a lifting force supplementing said normal force.

4. The propulsion system of claim 2, further comprising guidance magnets laterally arranged on said engagement means, for stabilizing a load of said propulsion system.

5. The propulsion system of claim 1, wherein said force-generating means comprises means for applying phased currents to coils arranged on one of said translator and stator, but not both.

6. The propulsion system of claim 5, each of said translator and said stator comprising a plurality of linear, spaced projections.

7. The propulsion system of claim 6, wherein each of said coils is individually wrapped around a separate projection of said stator or translator

8. The propulsion system of claim 7, wherein said projections and coils when energized by application of said currents form magnetic poles, and poles of said translator and said stator have a spacing and ratio relative to each other such that said phased currents generate propulsion without flux reversal.

9. The propulsion system of claim 8, wherein said ratio is 4 translator poles to 6 stator poles.

10. The propulsion system of claim 8, wherein said ratio is at least 6 translator poles to 6 stator poles.

11. A propulsion system comprising:
a first stator and a first translator configured to be in electromagnetic engagement with each other; and
a second stator and a second translator configured to be in electromagnetic engagement with each other;
wherein said second stator and said second translator have an orientation which is substantially at right angles to an orientation of said first stator and said first translator.

12. The propulsion system of claim 11, further comprising first force-generating means for application to one of said first translator and first stator to generate a first propulsive force in combination with a first normal force acting in a direction substantially perpendicular to a direction of said first propulsive force; and
second force-generating means for application to one of said second translator and second stator to generate a second propulsive force in combination with a normal force acting in a direction substantially perpendicular to a direction of said second propulsive force;
wherein said second propulsive force acts in substantially in the same direction as a direction of said first propulsive force; and
said second normal force acts in a direction substantially perpendicular to a direction of said first normal force.

13. The propulsion system of claim 11, further comprising engagement means configured to engage a support structure, said engagement means bringing said first stator and said first translator into a substantially linear spaced relationship with each other,
and said second stator and said second translator into a substantially linear spaced relationship with each other.

14. A transportation system comprising:
a support structure;
a pallet configured to be propelled along said support structure; and
a propulsion system for propelling said pallet and comprising:
a stator and a translator configured to be in electromagnetic engagement with each other; and
force-generating means for application to one of said translator and stator to generate a propulsive force in combination with a normal force acting in a direction substantially perpendicular to said propulsive force;
wherein said pallet is further configured to receive and convey a load along said support structure.

15. The transportation system of claim 14, wherein said load is an individual personal vehicle.

16. The transportation system of claim 14, said propulsion system further comprising engagement means configured to engage said support structure and bringing said stator and said translator into a substantially linear spaced relationship with each other.

17. The transportation system of claim 14, said propulsion system further comprising levitation magnets arranged on said engagement means, for providing a lifting force supplementing said normal force.

18. The transportation system of claim 14, said propulsion system further comprising guidance magnets laterally arranged on said engagement means, for stabilizing a load of said propulsion system.

19. The transportation system of claim 14, wherein said support structure is an elevated track.

20. The transportation system of claim 14, wherein said support structure comprises a steel I-beam.

21. The transportation system of claim 14, wherein said stator is arranged along said support structure.

22. A propulsion system comprising:
a stator and a translator configured to be in electromagnetic engagement with each other, each of said translator and said stator comprising a plurality of linear, spaced projections;
coils arranged on one of said translator and stator, but not both, each of said coils being individually wrapped around a separate projection of said stator or translator; and
means for applying phased currents to said coils;
wherein said projections and coils when energized by application of said currents form magnetic poles, and a pattern of time-varying magnetic flux propagated through said poles generates a propulsive force in combination with a normal force acting in a direction substantially perpendicular to a direction of said propulsive force.

23. The propulsion system of claim 22, wherein poles of said translator and said stator have a spacing and ratio relative to each other such that said phased currents generate propulsion without flux reversal.

24. The propulsion system of claim 23, wherein said ratio is at least 6 translator poles to 6 stator poles.

25. The propulsion system of claim 22, wherein each of said stator and translator comprises a plurality of bonded laminations.
